(19) United States
(12) Patent Application Publication
(10) Pub. No.: US 2010/0000388 A1
(43) Pub. Date: Jan. 7, 2010

(54) MACHINE TOOL, IN PARTICULAR A HANDHELD JIGSAW

(75) Inventors: Thilo Koeder, Gerlingen (DE); Joachim Platzer, Remseck-Hochberg (DE); Ulli Hoffmann, Niefern-Oeschelbronn (DE)

Correspondence Address: MERCHANT & GOULD PC, P.O. BOX 2903, MINNEAPOLIS, MN, 55402-0903, US

(73) Assignee: Robert Bosch GmbH, Stuttgart (DE)

(21) Appl. No.: 12/496,404

(22) Filed: Jul. 1, 2009

(30) Foreign Application Priority Data
Jul. 2, 2008 (DE) 10 2008 040 069.6

(51) Int. Cl. B26D 7/00; B23D 51/10

(52) U.S. Cl. 83/521; 30/392

(57) ABSTRACT

A machine tool, in particular in the form of a handheld jigsaw, is equipped with an observation device that is pointed at the field of work of its working tool, whose sensor technology that is created in particular by a camera is connected by a transmission device with the output point of the observation device that is provided on the side of the housing.

### TECHNICAL FIELD

The invention concerns a machine tool, in particular a handheld jigsaw, according to the generic term of claim 1.

### BACKGROUND

Contingent on the handling and/or construction the view of the user at machine tools, also at handheld jigsaws, is often limited to the field of work of its working tool on the side of the work piece, which makes the work difficult and which can also impair the work results. Therefore it is worked with auxiliary devices, which shall improve the viewing conditions in the field of work amongst others as an illuminating device or which shall enable an indirect observation of the field of work in the embodiment as observation devices. Both contingent on the side of the machine tool in the area to the field of work, and therefore also in the area that is already occupied amongst others by the working tool, the placement of additional elements, which are space-intensive and which require a special placement contingent upon work.

### SUMMARY

The invention is based on the task to create a machine tool of the type mentioned at the beginning regarding the arrangement and the embodiment of its observation device in such a way that a secure and good observation of the field of work is also achieved under difficult conditions.

This task is solved according to the invention with the characteristics of claim 1. The sub-claims provide useful improvements.

The sensor technology, which is in particular arranged as a camera, is arranged distanced to the output point of the observation device against the field of work at the solution according to the invention, so that limitations due to space issues are already omitted for placing the sensor technology, in particular the camera in the area of the field of work and the installation space intensive sensor technology, in particular in the form of a camera can be relocated in the areas of the machine tool, thus for example in the handle area of the machine tool that is arranged as a jigsaw, in which more space is available depending on the function.

Furthermore different optical transmission arrangements are provided in the range of the invention, which can be arranged in the transition from the sensor technology to the output point and which are partially uncritical themselves regarding the placement as well as open up additional possibilities, if necessary even used in combination. Such optical transmission arrangements can for example be fiber optics, lens systems or mirror systems, whereby in particular mirror systems also open up the possibility of ray guidance in the transition between the sensor technology, in particular in the form of a camera, and a corresponding redirection mirror that is pointed at the field of work.

Furthermore mirror- and lens systems also provide the possibility of the ray widening with a different resolution in different axis directions, as for example the aimed, magnified detection of the width of a working line that runs on the side of the work piece through the field of work.

On the basis of the aimed and precise detection of such a working line by the observation device according to the invention even a reliable, in particular half-automatic tracking of this working line is possible by the working tool of the machine tool during working operation, if the characteristic data of the working line that has been detected by the sensor technology, in particular the camera, is delivered over a signal processing unit to a control- and adjustment unit and by the latter the working tool is lead along the working line.

### BRIEF DESCRIPTION OF THE DRAWINGS

Further details and characteristics of the invention arise from the claims, the description and the drawings. The latter show in:

FIG. 1 shows schematically in a perspective side view a jigsaw as example of a handheld machine tool, which is provided with auxiliary devices, which at least support the operator in the machine guidance along a default working line,

FIG. 2 shows schematically a further simplified side view of a basic set-up of a jigsaw with a configuration of an observation device for the field of work of the jigsaw according to the invention, and

FIG. 3 shows schematically an illustration of an extract of a jigsaw with an illustration of an observation device in a further embodiment schematically shown within it.

### DETAILED DESCRIPTION

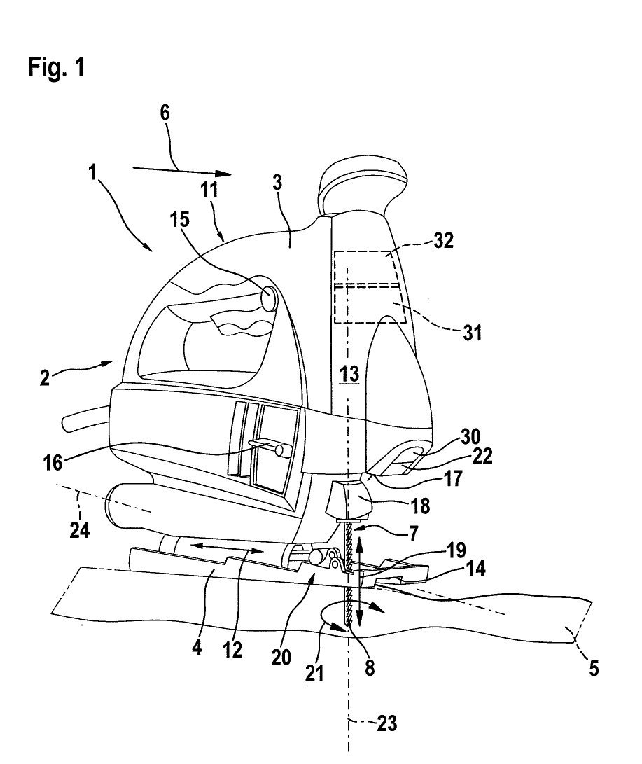

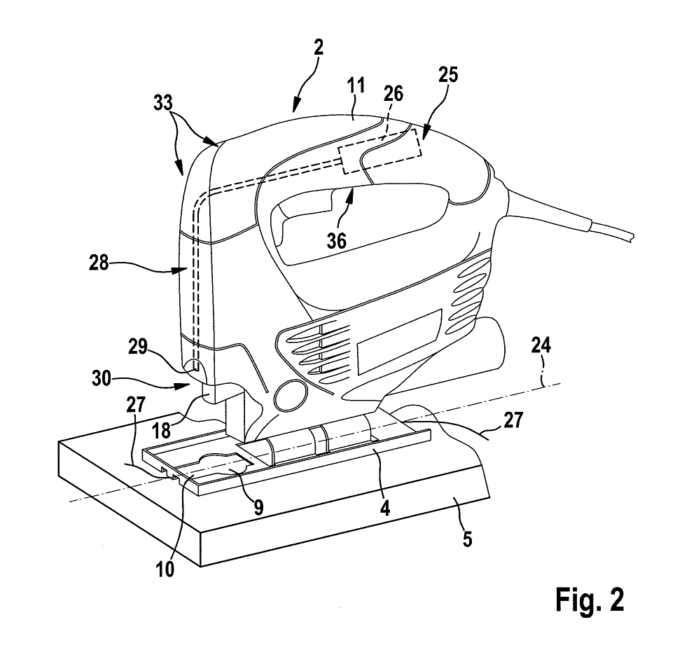

FIG. 1 shows a jigsaw 2 as an example of a handheld machine tool 1, which is supported by a base plate 4 on a work piece 5. With regard to the working direction 6 in the front area of the jigsaw 2, whose housing is labeled with 3, it provides a saw blade 8 as a working tool 7 that is driven in stroke-movements in direction of the arrow 19. The related stroke operator is arranged in the above located area of the housing 3, whose front wall 13 runs in the direction of the slot 18 for the saw blade 8 towards a step 17, which is located overlaying the saw blade 8 and the saw blade slot 18 and in whose transition towards the front wall 13 the output point 30 of a observation device 33 is located as it is for example illustrated in FIG. 2. The output point 30 is located in observation direction opposed to field of work 9 of the saw blade 8 on the side of the work piece, with which a recess 14 corresponds on the side of the base plate 4, which infiltrated by the saw blade 8. As indicated, in the area of the output point 30 a further illuminating arrangement 22 that is pointed at the field of work 9 can be provided.

FIG. 1 illustrates the saw blade 8 in a direction, which corresponds with its straight working direction, which is equivalent to the regulation working operation of the jigsaw 2, in which the saw blade 8 spreads out with its flat sides in the direction of the longitudinal axis 24 of the jigsaw 2. The jigsaw 2 that is shown in FIG. 1 can furthermore be operated in other operation types, one of which is the so-called pendulum stroke operation, at which the saw blade 8 is driven overlaid to the stroke drive (arrow 19) towards the pendulum direction (arrow 12) over the actuator 20. A further third operation type is indicated by arrow 21, which illustrates that the saw blade 8 has to be rotated from its stretching that corresponds with the straight working direction around its rotation axis 23 in rotational positions that are angled towards the longitudinal axis 24. This third operation type represents the so-called scrolling-mode, in which the saw blade 8 is pointed at a working line 27 that deviates from the course of the longitudinal axis 24 by rotating it around its rotation axis 23 and in which it follows this working line 27.

Therefore a working direction can be achieved that deviates from the longitudinal direction (longitudinal axis 24) of the jigsaw 2 by the rotational position of the saw blade 8. In the scrolling-mode at a sensory detection the course of each working line 27 is converted computer-based in adjusting commands for an actuator, over which the saw blade 8 is adjusted on a rotational position that corresponds the course of the working line 27. According to this automatic tracking of each working line 27 by changing the rotational position of the saw blade 8 a half-automatic working operation results, at which the operator that is holding the jigsaw 2 has basically only to take over the advance of the jigsaw 2 and that roughly in the direction of the corresponding working line 27, but the direct tracking of the working line 27 takes place in a mechanically controlled manner by the saw blade 8.

An exact tracking of the working line 27 by the saw blade 8 requires besides the mentioned mechanical requirements also and especially an exact detection of each working line 27. That takes place in the area of a detection area 10 as indicated in FIG. 2 that is adjoining the field of work 9 and is bounded by the recess 14, on which the output point 30 is pointed.

From a constructional point of view special limitations are provided regarding the output point 30, namely due to handling reasons as well as due to the visibility of the user on the field of work 9 that is necessary for various purposes and due to the constructional space that is required for other purposes.

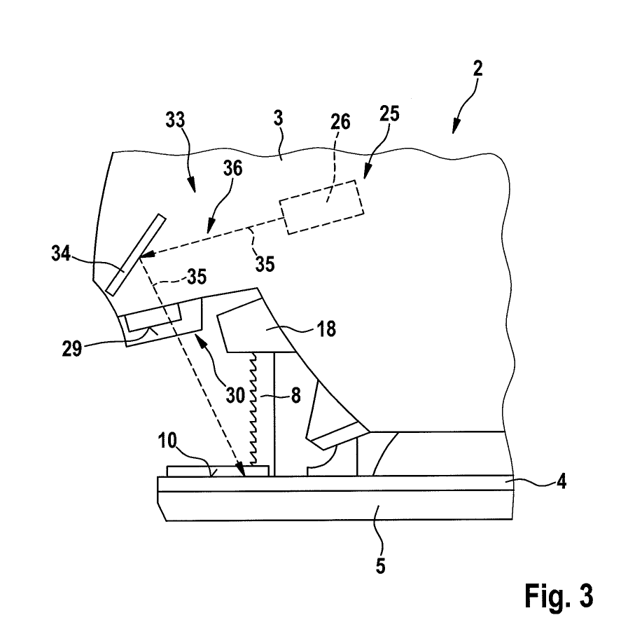

In order to come to a solution that is advantageously in its function and its effort despite these limitations, as it is shown in FIGS. 2 and 3, the observation device 33 is arranged distanced to the output point 30 with regard to its sensor technology 25 that is in particular formed by a camera 26, and preferably in the area of a handle, illustrated by a handle part 11 of the jigsaw 2, and a transition between the output point 30 and the sensor technology 25 or the camera 26 is bridged by a transmission arrangement 36, which is created in the embodiment according to FIG. 2 by fiber optics 28. The particularly flexible fiber optics 28 can for example be created by a glass fiber cable. Outgoing towards the output point 30 it is symbolically indicated in FIG. 2 that the fiber optics 28 are assigned to a lens system, illustrated by the lens 29, which can be integrated in it as a part of the cover on the housing side and therefore has only a minimized required space. Differing from the shown embodiment the fiber optics 28 can also be construed protected by a shroud, in particular also spreading over the housing 3 in the direction on the detection area 10, preferably safely protuberant, since it creates no disturbing element regarding the observation of the detection area 10 due to its slim shape.

A lens arrangement and/or an adjustable lens arrangement in the form of a lens in the transition between the fiber optics 28 and the camera 26 can be provided also at the output point 30 as it is at the entrance to the fiber optics 28.

If a covering, if necessary in the form of a lens, is provided at the entrance in the area of the output point 30, it proves to be useful with regard to a fault-free working that is not impaired by dirt of the covering, to blow at the output point if necessary and/or to layer it dirt-resistant and/or to structure its surface in such a way that at least partially a minimized dirt-sensitivity is provided, as it is for example known for taillights of motor vehicles.

In the embodiment according to FIG. 3 on the other hand an observation device 33 is used, but at this solution no hard-wired connection of the camera 26 that creates the sensor technology 25 to the output point 30 is provided; in fact the transmission arrangement 36 is constructed by using a mirror system with a redirection mirror 34, which is arranged in the dotted ray path 35 between the detection area 10 and the camera 26. It is furthermore shown in FIG. 3 that also at such a solution lens systems can be used in addition, here illustrated by a lens 29 at the output point 30.

The construction of the lenses (for example 29) as well as the mirrors (for example 34) cannot only take place by a magnified illustration of the course of the working line 27 that has to be observed in the detection area 10. In fact the working line 27 can also be illustrated blurred, for example only magnified in its width, so that an optimal pointing of the saw blade 8 on to the corresponding lens middle is enabled by the changed resolution.

1. A machine tool, comprising:
a field of work; and
an observation device comprising;
an output point pointed at the field of work;
a sensor technology that is arranged distanced to the output point; and
an optical transmission arrangement that couples the sensor technology to the output point.

2. The machine tool of claim 1, wherein the optical transmission arrangement comprises fiber optics.

3. The machine tool of claim 1, wherein the optical transmission arrangement comprises a lens system with at least one lens.

4. The machine tool of claim 1, wherein the optical transmission arrangement comprises a mirror system with at least one mirror.

5. The machine tool of claim 1, wherein the transmission arrangement is arranged on a side of the output point with an adjustable lens that is pointed at the field of work.

6. The machine tool of claim 5, wherein the adjustable lens is at least one of dirt-protected; and dirt-resistant.

7. The machine tool of claim 1, wherein the sensor technology is working in angled directions with a different resolution due to a steel widening.

8. The machine tool of claim 1, wherein a redirection mirror is arranged in a ray path of the sensor technology to the field of work.

9. The machine tool of claim 1, wherein a camera is arranged in a handle part of the machine tool.

10. The machine tool of claim 1, further comprising:
an arithmetic unit arranged after the sensor technology to operate on characteristic data that is detected by the sensor technology of a working line that serves as a working way target; and
a control and adjustment unit that processes the characteristic data, wherein the machine tool, in particular a jigsaw, comprises a saw blade that is adjusted in a working direction in such a way that a sawing direction of the saw blade coincides with the working line.
